(19) United States
(12) Patent Application Publication
(10) Pub. No.: US 2024/0178584 A1
(43) Pub. Date: May 30, 2024

(54) MANUFACTURING METHOD FOR TERMINAL-EQUIPPED ELECTRIC WIRE, AND TERMINAL-EQUIPPED ELECTRIC WIRE

(71) Applicant: YAZAKI CORPORATION, Tokyo (JP)

(72) Inventors: Kazuma Watanabe, Makinohara-shi (JP); Naoki Ito, Makinohara-shi (JP)

(21) Appl. No.: 18/503,053

(22) Filed: Nov. 6, 2023

(30) Foreign Application Priority Data
Nov. 30, 2022 (JP) 2022-191053

(51) Int. Cl. H01R 4/20; H01R 4/18; H01R 43/048

(52) U.S. Cl. CPC H01R 4/20; H01R 4/183; H01R 43/048

(57) ABSTRACT

A manufacturing method for a terminal-equipped electric wire includes a core wire inserting step S1 and a crimping step S2. A die main body of a caulking die includes a caulking convex part. The caulking convex part is provided protruding from a pressing surface of the die main body toward a core wire crimp part, has a rectangular cross section along an axial direction, and has a length in the axial direction twice or more the thickness of the thickness of the core wire crimp part before crimping. Using such a caulking die, at the crimping step, the core wire crimp part into which a core wire is inserted at the core wire inserting step is pressed by the pressing surface of the die main body to form a caulking region.

### CROSS-REFERENCE TO RELATED APPLICATION(S)

The present application claims priority to and incorporates by reference the entire contents of Japanese Patent Application No. 2022-191053 filed in Japan on Nov. 30, 2022.

### BACKGROUND OF THE INVENTION

### 1. Field of the Invention

The present invention relates to a manufacturing method for a terminal-equipped electric wire, and a terminal-equipped electric wire.

### 2. Description of the Related Art

As a conventional terminal-equipped electric wire, for example, Japanese Patent Application Laid-open No. 2018-174099 describes a crimp terminal including an electric wire insertion part to which a covering part of an electric wire is inserted and a core wire crimp part where a core wire of the electric wire is crimped, in which the core wire crimp part is caulked by a tool while the core wire of the electric wire is inserted in the core wire crimp part. In this crimp terminal, the thickness of the core wire crimp part is formed to be equal to the thickness of a small-diameter part of the electric wire insertion part after the core wire crimp part is caulked by the tool.

Incidentally, in the crimp terminal described above in Japanese Patent Application Laid-open No. 2018-174099, the core wire crimp part is caulked by the tool with a pressing surface formed to be flat; however, in some cases, the core wire crimp part may be caulked by a tool with a pressing surface having a convex part. In those cases, if a pressing region of the convex part that presses the core wire crimp part is made smaller in the crimp terminal, the thickness of the core wire crimp part in a part pressed by the convex part becomes smaller, and the electrical connection with the core wire may deteriorate. On the other hand, if the pressing region of the convex part is increased in the crimp terminal, the size of the core wire crimp part may increase.

### SUMMARY OF THE INVENTION

The present invention has been made in view of the above, and it is an object of the present invention to provide a manufacturing method for a terminal-equipped electric wire in which a core wire crimp part and a core wire can be connected properly, and a terminal-equipped electric wire.

To achieve the object of the present invention, a manufacturing method for a terminal-equipped electric wire according to one aspect of the present invention includes inserting a core wire with conductivity exposed from an end part of an insulating cover of an electric wire into a core wire crimp part of a crimp terminal including an electric connection part that is connectable to a counterpart connection member and the core wire crimp part formed in a tubular shape around an axial line; and crimping the core wire crimp part to the core wire by causing a caulking die to caulk the core wire crimp part into which the core wire is inserted at the inserting the core wire, wherein the caulking die includes a caulking part that caulks the core wire crimp part to form a caulking region, the caulking part includes a convex part provided protruding from a pressing surface of the caulking part toward the core wire crimp part, having a rectangular cross section along an axial direction along the axial line, and having a length in the axial direction twice or more a thickness of the core wire crimp part before crimping, and at the crimping the core wire crimp part, the core wire crimp part into which the core wire is inserted at the inserting the core wire is pressed by the pressing surface of the caulking part to form the caulking region and is pressed by the convex part to form a concave part in the caulking region, so that the core wire crimp part is crimped to the core wire.

A terminal-equipped electric wire according to another aspect of the present invention includes an electric connection part that is connectable to a counterpart connection member; and a core wire crimp part that is formed in a tubular shape around an axial line and crimped to a core wire with conductivity exposed from an end part of an insulating cover of an electric wire, wherein the core wire crimp part includes a caulking region formed in a depressed manner, the caulking region includes a concave part, and a length of the concave part in an axial direction along the axial line is twice or more a thickness of the core wire crimp part before crimping.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a structure example of a crimp terminal according to an embodiment;

FIG. 2 is a cross-sectional view illustrating a structure example of the crimp terminal according to the embodiment;

FIG. 3 is a cross-sectional view illustrating a manufacturing process of a terminal-equipped electric wire according to the embodiment;

FIG. 4 is an image in which a core wire crimp part according to Comparative Example is crimped to form a concave part (the length of a caulking die in a longitudinal direction/the thickness of the core wire crimp part=1.4 times);

FIG. 5 is an image in which a core wire crimp part according to the embodiment is crimped to form a concave part (the length of the caulking die in the longitudinal direction/the thickness of the core wire crimp part=2.3 times);

FIG. 6 is an image in which the core wire crimp part according to the embodiment is crimped to form the concave part (the length of the caulking die in the longitudinal direction/the thickness of the core wire crimp part=3.6 times);

FIG. 7 is a diagram expressing a relationship between the length of the caulking die in the longitudinal direction and the thickness of the core wire crimp part according to the embodiment; and

FIG. 8 is a flowchart expressing a manufacturing method for the terminal-equipped electric wire according to the embodiment.

### DETAILED DESCRIPTION OF THE PREFERRED EMBODIMENTS

### Embodiment

A mode (embodiment) for carrying out the present invention will be described in detail with reference to the drawings. The present invention is not limited by the contents described in the following embodiment. The components described below include those that can be readily conceived by persons who are skilled in the art and those that are substantially the same. Furthermore, the structures to be described below can be combined as appropriate. In addition, various omissions, substitutions or changes in the structure can be made without departing from the gist of the present invention.

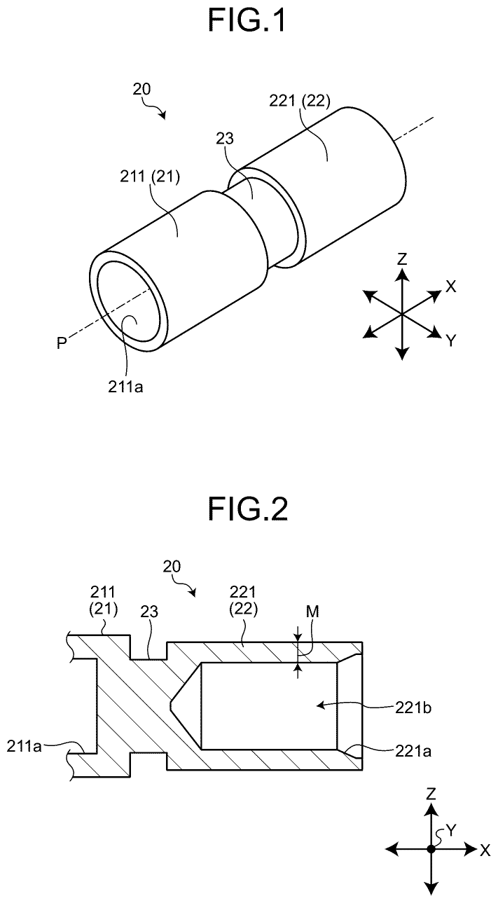

With reference to the drawings, a manufacturing method for a terminal-equipped electric wire 1, and the terminal-equipped electric wire 1 according to an embodiment will be described. The terminal-equipped electric wire 1 is electrically connected to a counterpart terminal (not illustrated), and as illustrated in FIG. 1 to FIG. 3, includes an electric wire 10 and a crimp terminal 20. In the following description, a longitudinal direction of the crimp terminal 20 is referred to as an axial direction X. The axial direction X also corresponds to a direction along an axial line P of a core wire crimp part 22 to be described below. A crimping direction Z is a direction in which the core wire crimp part 22 is crimped. An intersecting direction Y is a direction that intersects with the axial direction X and the crimping direction Z. The axial direction X, the intersecting direction Y, and the crimping direction Z intersect with each other and are typically orthogonal to each other. The manufacturing method for the terminal-equipped electric wire 1, and the terminal-equipped electric wire 1 will be described below in detail.

The electric wire 10 includes a core wire 11 and an insulating cover 12. The core wire 11 includes, for example, a bundle of a plurality of conductive metal strands formed by a metal material such as copper. The core wire 11 includes a core wire exposed part 111 that is exposed from an end part of the insulating cover 12. The core wire exposed part 111 is formed by cutting and removing an end part of the insulating cover 12 in the axial direction X so as to expose a part of the core wire 11. In other words, the core wire exposed part 111 is a portion exposed because the end part of the insulating cover 12 is peeled. The core wire exposed part 111 is crimped in a state of being accommodated in the core wire crimp part 22 of the crimp terminal 20, which will be described below.

The insulating cover 12 has an insulating property and covers the core wire 11. The insulating cover 12 is, for example, made of an insulating resin material (PP, PVC, cross-linked PE, etc. The material is selected suitably in consideration of abrasion resistance, chemical resistance, heat resistance, or the like). The insulating cover 12 covers a part of the core wire 11 that excludes the core wire exposed part 111.

The crimp terminal 20 is a terminal formed by a metal member such as copper, a copper alloy, aluminum, or an aluminum alloy and is, for example, a closed barrel crimp terminal. The crimp terminal 20 is a female terminal and is electrically connected to a male terminal (not illustrated) as a counterpart connection member. The crimp terminal 20 includes an electric connection part 21, the core wire crimp part 22, and a coupling part 23.

The electric connection part 21 is a portion that is formed by extending along the axial direction X, to which the male terminal is inserted. The electric connection part 21 has a tubular body 211 formed in a tubular shape around the axial line P, and the male terminal is inserted into an interior space part 211a of the tubular body 211. The electric connection part 21 is electrically connected to the male terminal while the male terminal is inserted.

The core wire crimp part 22 is a portion where the core wire exposed part 111 of the electric wire 10 is crimped. The core wire crimp part 22 is a hollow tubular portion formed integrally with the electric connection part 21, and is provided on the opposite side of the electric connection part 21 along the axial direction X via the coupling part 23. The core wire crimp part 22 includes a tubular body 221.

The tubular body 221 is a portion formed in a tubular shape around the axial line P. In a state before the core wire exposed part 111 is crimped to the tubular body 221, an inner diameter of the tubular body 221 is larger than an outer diameter of an outer peripheral surface of the core wire exposed part 111. Thus, the tubular body 221 can accommodate the core wire exposed part 111 inserted thereinto. The tubular body 221 includes an opening part 221a and an interior space part 221b.

The opening part 221a is a portion opened so that the core wire exposed part 111 can be inserted, and is formed in a circular shape. The opening part 221a is provided at an end part of the tubular body 221 on the opposite side of the coupling part 23.

The interior space part 221b is a space part provided inside the tubular body 221 to accommodate the core wire exposed part 111. The interior space part 221b is formed with the length in the axial direction X equal to the length of the core wire exposed part 111 in the axial direction X. Thus, the interior space part 221b can accommodate the core wire exposed part 111 for sure.

The coupling part 23 is a portion that couples the electric connection part 21 and the core wire crimp part 22. The coupling part 23 exists between the electric connection part 21 and the core wire crimp part 22 in the axial direction X, and is integrated with the electric connection part 21 and the core wire crimp part 22.

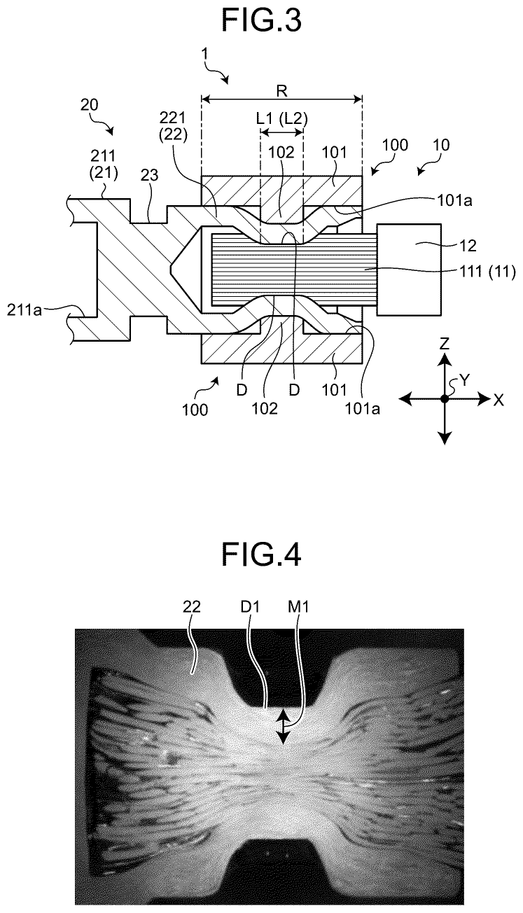

By the way, when crimping the core wire crimp part 22 to the core wire exposed part 111 by caulking, a caulking die 100 is used. This caulking die 100 includes a pair of die main bodies (caulking parts) 101, 101 that are butted against each other, and each die main body 101 includes a pressing surface 101a and a caulking convex part 102. The pressing surface 101a is a surface part that presses the tubular body 221 of the core wire crimp part 22 from the outside to the inside. The caulking convex part 102 is provided protruding from the pressing surface 101a toward the core wire crimp part 22, and is formed in an annular shape around the axial line P. The caulking convex part 102 is located at a center of the pressing surface 101a in the axial direction X as illustrated in FIG. 3. The caulking convex part 102 has a rectangular cross section taken along the axial direction X. A length L1 of the caulking convex part 102 in the axial direction X is twice or more a thickness M of the core wire crimp part 22 before crimping.

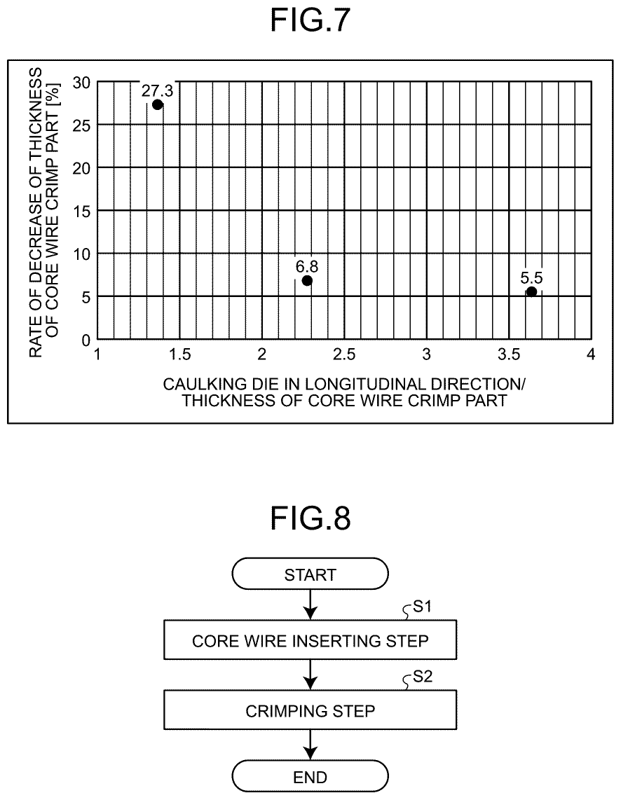

Here, FIG. 4 to FIG. 7 express the rate of decrease in the thickness of the core wire crimp part 22 when the length L1 of the caulking convex part 102 in the axial direction X is 1.4 times, 2.3 times, and 3.6 times the thickness M of the core wire crimp part 22 before the crimping. FIG. 4 is an example in which the length L1 of the caulking convex part 102 in the axial direction X is 1.4 times the thickness M of the core wire crimp part 22 before the crimping. In this case, as expressed in FIG. 4 and FIG. 7, the rate of decrease of a thickness M2 of the core wire crimp part 22 in a concave part D1 is 27.3%.

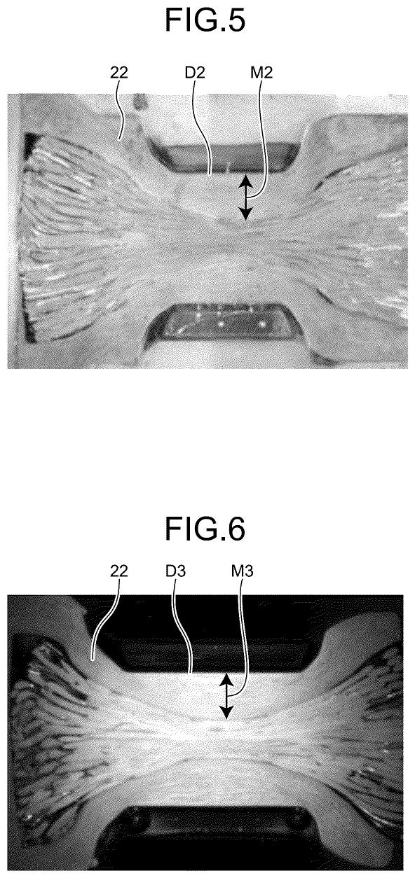

FIG. 5 is an example in which the length L1 of the caulking convex part 102 in the axial direction X is 2.3 times the thickness M of the core wire crimp part 22 before the crimping. In this case, as illustrated in FIG. 5 and FIG. 7, the rate of decrease in the thickness M2 of the core wire crimp part 22 in a concave part D2 is 6.8%, indicating that the rate of decrease can be suppressed compared to the above example where the thickness is 1.4 times.

FIG. 6 is an example in which the length L1 of the caulking convex part 102 in the axial direction X is 3.6 times the thickness M of the core wire crimp part 22 before the crimping. In this case, as illustrated in FIG. 6 and FIG. 7, the rate of decrease in a thickness M3 of the core wire crimp part 22 in a concave part D3 is 5.5%, indicating that the rate of decrease can be suppressed compared to the above examples where the thickness is 1.4 times and 2.3 times. Since the rate of decrease is not very different between the aforementioned cases of 2.3 times and 3.6 times and the rate of decrease is suppressed to be low in the case of 2.3 times, the length L1 of the caulking convex part 102 is preferably twice or more the thickness M of the core wire crimp part 22 before the crimping. The maximum length of the length L1 of the caulking convex part 102 is defined according to the total length of the core wire crimp part 22 in the axial direction X. In other words, the maximum length of the length L1 of the caulking convex part 102 is shorter than the total length of the core wire crimp part 22 in the axial direction X.

The caulking convex parts 102 configured in this way are formed in the annular shape around the axial line P when the pair of die main bodies 101, 101 are closed (butted together) so that they get close to each other in the crimping direction Z. The inner diameter of the caulking convex parts 102 is smaller than the outer diameter of the core wire crimp part 22. As a result, the caulking convex parts 102 can caulk the core wire crimp part 22 around the axial line P with the pair of die main bodies 101, 101 closed.

Next, the method of manufacturing the terminal-equipped electric wire 1 by caulking the core wire crimp part 22 of the crimp terminal 20 using the caulking die 100 will be described. First, an operator prepares the electric wire 10 whose core wire 11 is entirely covered with the insulating cover 12. The operator then cuts and removes an end part of the insulating cover 12 of the electric wire 10 to form the core wire exposed part 111 where a part of the core wire 11 is exposed. The operator inserts the formed core wire exposed part 111 into the tubular body 221 of the core wire crimp part 22 (core wire inserting step S1). Next, the operator crimps the core wire crimp part 22 and the core wire exposed part 111 with the core wire exposed part 111 inserted into the core wire crimp part 22 (crimping step S2). The operator, for example, closes the pair of die main bodies 101, 101 in the crimping direction Z with the core wire exposed part 111 inserted into the core wire crimp part 22, and then closes these die main bodies 101, 101 by butting them against each other. Then, the operator causes the pressing surface 101a of the die main body 101 to press the core wire crimp part 22 to which the core wire 11 is inserted at the core wire inserting step S1 to form a caulking region R, and causes the caulking convex part 102 with the length L1 twice or more the thickness M of the core wire crimp part 22 before the crimping to press the core wire crimp part 22 to form a concave part D in the caulking region R, so that the core wire crimp part 22 is crimped to the core wire 11 and thus, the terminal-equipped electric wire 1 is manufactured. In the manufactured terminal-equipped electric wire 1, the concave part D in the caulking region R has a length L2 in the axial direction X that is twice or more the thickness M of the core wire crimp part 22 before the crimping.

As described above, the manufacturing method for the terminal-equipped electric wire 1 according to the embodiment includes the core wire inserting step S1 and the crimping step S2. At the core wire inserting step S1, the core wire 11 with conductivity exposed from the end part of the insulating cover 12 of the electric wire 10 is inserted into the core wire crimp part 22 of the crimp terminal 20, which includes the electric connection part 21 that is connectable to the counterpart connection member and the core wire crimp part 22 that is formed in the tubular shape around the axial line P. At the crimping step S2, the core wire crimp part 22 into which the core wire 11 is inserted at the core wire inserting step S1 is caulked by the caulking die 100 and crimped to the core wire 11. Here, the caulking die 100 includes the die main body 101 that forms the caulking region R by caulking the core wire crimp part 22. The die main body 101 includes the caulking convex part 102. The caulking convex part 102 is provided protruding from the pressing surface 101a of the die main body 101 toward the core wire crimp part 22, having a rectangular cross section along the axial direction X, and having the length L1 in the axial direction X twice or more the thickness M of the core wire crimp part 22 before the crimping. By using such a caulking die 100, the core wire crimp part 22 to which the core wire 11 is inserted at the core wire inserting step S1 is pressed by the pressing surface 101a of the die main body 101 so as to form the caulking region R and pressed by the caulking convex part 102 so as to form the concave part D in the caulking region R; thus, the core wire crimp part 22 is crimped to the core wire 11 at the crimping step S2.

With such a structure, in the manufacturing method for the terminal-equipped electric wire 1, the length of the caulking convex part 102 of the caulking die 100 in the axial direction X is made the proper length, so that the reduction in thickness of the concave part D of the core wire crimp part 22 can be suppressed and the enlargement of the core wire crimp part 22 can be suppressed. As a result, the core wire crimp part 22 and the core wire 11 can be connected properly.

The terminal-equipped electric wire 1 includes the electric connection part 21 that is connectable to the counterpart connection member, and the core wire crimp part 22 that is formed in the tubular shape around the axial line P and crimped to the conductive core wire 11 exposed from the end part of the insulating cover 12 of the electric wire 10. The core wire crimp part 22 includes the caulking region R formed in a depressed manner. This caulking region R includes the concave part D. The length L2 of the concave part D in the axial direction X is twice or more the thickness M of the core wire crimp part 22 before the crimping. By this structure, in the terminal-equipped electric wire 1, the reduction in thickness of the concave part D of the core wire crimp part 22 can be suppressed and the enlargement of the core wire crimp part 22 can be suppressed. As a result, the core wire crimp part 22 and the core wire 11 can be connected properly.

In the manufacturing method for a terminal-equipped electric wire, and the terminal-equipped electric wire according to the present embodiment, the reduction in thickness of the concave part of the core wire crimp part can be suppressed and the enlargement of the core wire crimp part can be suppressed. As a result, the core wire crimp part and the core wire can be connected properly.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A manufacturing method for a terminal-equipped electric wire, comprising:
inserting a core wire with conductivity exposed from an end part of an insulating cover of an electric wire into a core wire crimp part of a crimp terminal including an electric connection part that is connectable to a counterpart connection member and the core wire crimp part formed in a tubular shape around an axial line; and
crimping the core wire crimp part to the core wire by causing a caulking die to caulk the core wire crimp part into which the core wire is inserted at the inserting the core wire, wherein
the caulking die includes a caulking part that caulks the core wire crimp part to form a caulking region,
the caulking part includes a convex part provided protruding from a pressing surface of the caulking part toward the core wire crimp part, having a rectangular cross section along an axial direction along the axial line, and having a length in the axial direction twice or more a thickness of the core wire crimp part before crimping, and
at the crimping the core wire crimp part, the core wire crimp part into which the core wire is inserted at the inserting the core wire is pressed by the pressing surface of the caulking part to form the caulking region and is pressed by the convex part to form a concave part in the caulking region, so that the core wire crimp part is crimped to the core wire.

2. A terminal-equipped electric wire comprising:
an electric connection part that is connectable to a counterpart connection member; and
a core wire crimp part that is formed in a tubular shape around an axial line and crimped to a core wire with conductivity exposed from an end part of an insulating cover of an electric wire, wherein
the core wire crimp part includes a caulking region formed in a depressed manner,
the caulking region includes a concave part, and
a length of the concave part in an axial direction along the axial line is twice or more a thickness of the core wire crimp part before crimping.
